(19) United States
(12) Patent Application Publication
(10) Pub. No.: US 2026/0369716 A1
(43) Pub. Date: Nov. 19, 2026

(54) LITHIUM METAL RECYCLING

(71) Applicant: Worcester Polytechnic Institute, Worcester, MA (US)

(72) Inventors: Yan Wang, North Andover, MA (US); Hao Zhou, Worcester, MA (US); Jaemin Kim, Worcester, MA (US)

(21) Appl. No.: 19/668,108

(22) Filed: May 5, 2026

Related U.S. Application Data
(60) Provisional application No. 63/800,605, filed on May 6, 2025.

(51) Int. Cl. H01M 10/54; C01D 15/02; C01D 15/08; C07F 1/02; C22B 3/44; C22B 7/00; C22B 26/12

(52) U.S. Cl. CPC H01M 10/54; C01D 15/02; C01D 15/08; C07F 1/02; C22B 3/44; C22B 7/006; C22B 26/12

(57) ABSTRACT

A recycling process for lithium metal anodes provides a scalable and economically viable approach using commercial acetone, where trace water gradually consumes lithium dendrites to reduce reactivity while simultaneously initiating a “self-driven” aldol condensation that drives safe lithium recovery. Beyond enabling sustainable development of rechargeable lithium metal batteries, this strategy also provides a framework for recycling other next-generation batteries that employ alkali-metal anodes with high reactivity.

### RELATED APPLICATIONS

This patent application claims the benefit under 35 U.S.C. § 119(e) of U.S. Provisional Patent App. No. 63/800,605, filed May 6, 2025, entitled “LITHIUM METAL RECYCLING,” incorporated herein by reference in entirety.

### BACKGROUND

Li-ion batteries (LIBs) have been widely applied in recent decades, particularly with respect to electric vehicles (EV) and plug-in electric vehicles (PHEV) which have been equipped with or directly powered by LIBs. LIBs have been widely used in portable electronics, electric vehicles and grid storage as dominant power sources. Li-ion batteries include a charge material, conductive powder and binder applied to or deposited on a current collector, typically a planar sheet of copper or aluminum. The charge material includes anode material, typically graphite or carbon, and cathode material, which includes a predetermined ratio of metal salts such as lithium, nickel, manganese, cobalt, aluminum, iron and phosphorous, defining a so-called “battery chemistry” of the Li-ion cells. The preferred battery chemistry varies between vendors and applications, and recycling efforts of Li-ion batteries typically adhere to a prescribed molar ratio of the battery chemistry in recycled charge material products. A purity of the constituent products is highly relevant to the quality and performance of the recycled cells, often relying on so-called “battery grade” materials, implying purity of at least 99.5%.

### SUMMARY

A recycling process for lithium metal anodes provides a scalable and economically viable approach using commercial acetone, where trace water gradually consumes lithium dendrites to reduce reactivity while simultaneously initiating a “self-driven” aldol condensation that drives safe lithium recovery. Beyond enabling sustainable development of rechargeable lithium metal batteries, this strategy also provides a framework for recycling other next-generation batteries that employ alkali-metal anodes with high reactivity.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a lithium recycling environment suitable for use with configurations herein;

FIGS. 2A-2B are a process flow of recycling spent Li-metal anodes (S-LMAs);

FIG. 3 shows XRD patterns of the S-LMA before and after immersion in acetone at the initial stage;

FIG. 4 shows a proton Nuclear Magnetic Resonance (NMR) spectrum of the commercial acetone used for the conversion;

FIG. 5 shows a proton NMR spectra of the solvent after the S-LMA was immersed and the white flocculent formation;

FIG. 6 shows a carbon NMR spectra of the solvent after the S-LMA was immersed and the white flocculent formation; and

FIG. 7 shows an XRD patterns of the dry products in stage 3 before and after adding H₂O and drying.

### DETAILED DESCRIPTION

The pursuit of higher energy density is rapidly advancing the commercialization of lithium metal batteries, however their safe and efficient recycling remains an unmet challenge. Existing approaches are largely designed for primary lithium metal batteries and are ill-suited to address the high reactivity and dendrite-rich anodes of rechargeable systems.

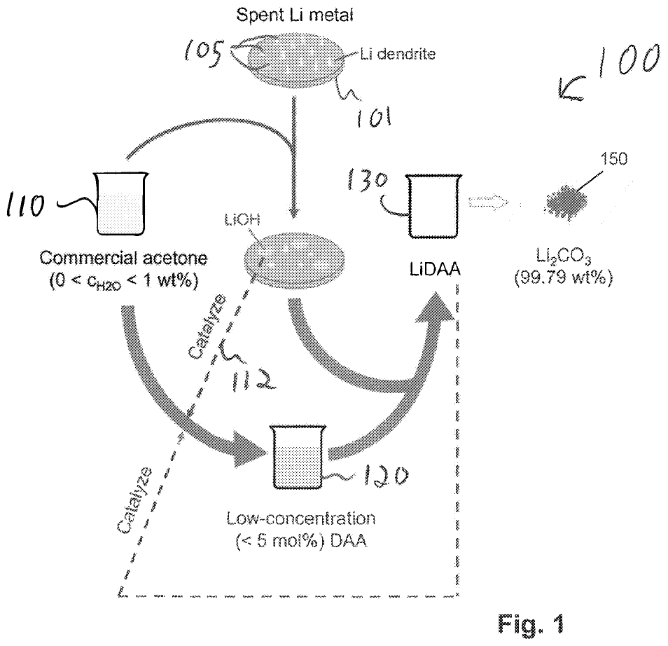

FIG. 1 is a context diagram of a lithium recycling environment 100 suitable for use with configurations herein. Rechargeable lithium (Li)-metal batteries with high energy densities are approaching large-scale commercialization but face challenges in recycling due to the high reactivity of spent Li-metal anodes (S-LMAs) 101. Configurations herein demonstrate a recovery strategy using commercial acetone or other suitable solvent containing <1.00 wt % water. Sub-percent water first reacts with the S-LMA 101 to form LiOH, which consumes Li dendrites 105 and mitigates safety risks. Then, LiOH catalyzes 112 acetone aldol condensation to low-concentration diacetone alcohol (DAA, <5 mol %) 120, which further reacts with the S-LMA 101 at acceptable rates and simultaneously drives the DAA production, thus achieving complete conversion of the S-LMA 101 while producing LiDAA (lithium alkoxide) 130. This approach yields high-purity Li₂CO₃ (99.79 wt %) 150, surpassing the battery-grade standard (99.50 wt %). The recovered Li₂CO₃ enables the synthesis of LiNi_{0.6}Mn_{0.2}Co_{0.2}O₂ cathodes with electrochemical performance comparable to those from commercial Li₂CO₃. Combining safety, scalability, and economic viability, this method provides a practical route for recycling rechargeable Li-metal batteries and offers insights for extending to other alkali-metal-based batteries.

Aldol condensation is an organic reaction where an enolate ion (formed from an aldehyde or ketone with -hydrogens) attacks another carbonyl molecule to form a -hydroxy carbonyl compound (aldol addition product). Under acidic or basic conditions with heat, this intermediate undergoes dehydration to form a stable-unsaturated carbonyl compound.

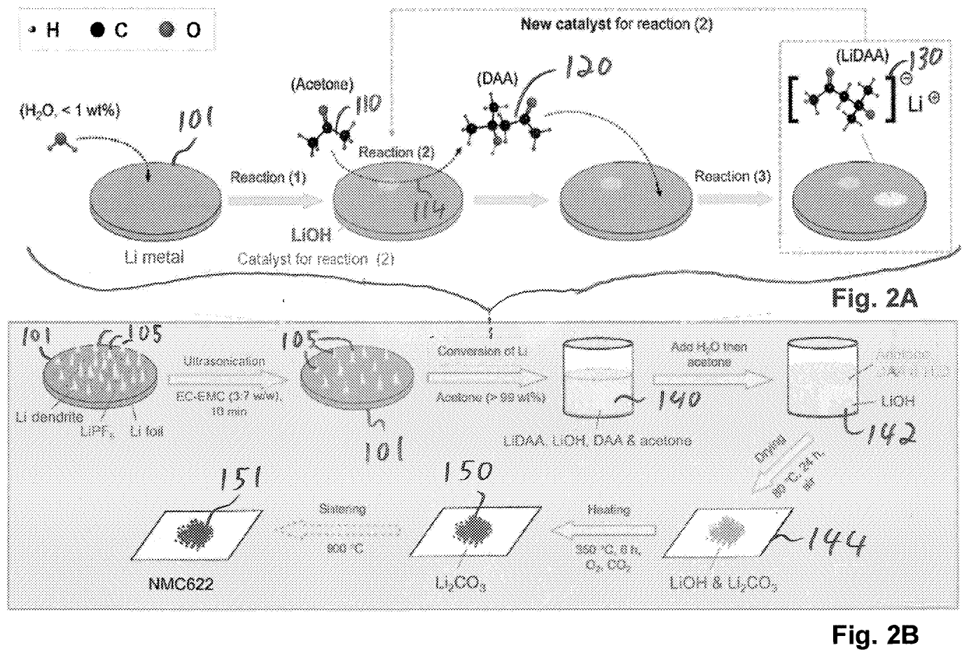

FIGS. 2A-2B are a process flow of recycling spent Li-metal anodes (S-LMAs) in the environment of FIG. 1. Configurations herein are based, in part, on the increasing demands for long-range electric vehicles and durable portable electronic devices have spurred the rapid advancement of batteries toward higher energy densities in recent years. Rechargeable lithium (Li)-metal batteries (LMBs), employing Li-metal anodes with an ultra-high specific capacity of 3,860 mAh g⁻¹, are expected to deliver energy densities up to two or even three times greater than those of current Li-ion batteries, which can well meet the requirements of the market.

Driven by such strong power, great progress in both material innovation and commercialization of LMBs has been made. Numerous strategies, such as localized high-concentration electrolyte design, fluorinated additives design for electrolytes, and three-dimensional structural design of negative current collectors, etc., have been investigated to mitigate the effect of Li dendrites 105, thereby achieving LMBs with high energy densities and long lifespan. By way of background, from 2018 to 2024, the energy densities of Li-metal pouch cells increased from 293.9 to 505.9 Wh kg⁻¹, while the lifespans were extended from 88% capacity retention after 100 cycles to 76% after 600 cycles. Li metal recycling has both commercial and environmental benefits, as the disposal of the spent Li-metal anodes (S-LMAs) poses environmental and safety risks, necessitating the development of viable recycling methods.

Unfortunately, conventional approaches to Li recycling, and in particular S-LMAs prone to dendrite accumulation, suffer from the shortcoming of high reactivity. In conventional approaches, a variety of recycling strategies, including high-temperature treatment, solvent leaching, and direct structural repair of spent electrodes have been attempted. Typical approaches may enable the spent electrodes to be reused in the forms of compounds of critical elements or even approaching pristine electrodes, thereby advancing the green and sustainable development of Li-ion batteries. In contrast, the high reactivity of S-LMA 101, attributed to the high specific surface area caused by producing Li dendrites during cycling, significantly limits its recovery, which is also the primary challenge in recovering S-LMA. Moreover, thermally unstable organic Li compounds formed on the S-LMA surface further constrain available recycling method options. As a result, nearly all conventional methods for recycling Li-ion batteries cannot be utilized for the S-LMA. Protic solvents are commonly used to treat spent Li metal in laboratories.

In some approaches, S-LMAs have been treated via direct reaction with water (H₂O), however, such a process is dangerous due to the fast reaction accompanied by an exothermic process (222.7 kJ mol⁻¹) and the production of flammable hydrogen gas, making it unsuitable for large-scale applications. Additionally, studies on recovering S-LMAs are rare and mostly focus on primary LMBs without Li dendrites. Most of the studies are built upon the reaction between Li metal and H₂O, and optimizations have been made to improve the safety, including slowing down the reaction by replacing H₂O with a H₂O-isobutanol mixture and avoiding large heat release at once based on stepwise thermal-chemical conversions where Li metal is first oxidized to lithium oxide before re-acting with H₂O. However, the high specific surface area will significantly accelerate the reactions of the S-LMA with the protic solvents, leading to high heat generation that may cause surface components decomposition and thermal runaway. In addition, oxidation using supercritical carbon dioxide (CO₂) combined with dry air has also been explored. However, this process tends to release more heat (368.2 kJ mol⁻¹, than the reaction between Li metal and H₂O, which may also cause safety concerns. In summary, the existing S-LMA recycling methods, originally developed for primary LMBs, fail to adequately address the complex reactivity of the S-LMA from spent rechargeable LMBs, rendering them unsuitable. Therefore, it would be beneficial to develop safer and more targeted methods for recovering the S-LMA 105 with high chemical activity.

Configurations herein present a method of recycling lithium from lithium metal anodes, including combining a recycling stream of spent lithium metal anodes (S-LMA) 101 and a solution of acetone and water 110. Acetone, C₃H₆O, or structurally CH₃COCH₃ or (CH₃)₂)CO, is a common solvent with many industrial uses. The approach recovers the S-LMA by using an aprotic solvent, commercial acetone (analytical reagent, >99.50%) that contains very little H₂O. Alternatively, another suitable solvent with trace elements to slowly react with dendrites 105 may be considered. Formation of LiOH results from the S-LMA and the H₂O, the LiOH catalyzes condensation of the acetone for forming diacetone alcohol (DAA). The S-LMA first reacts with H₂O at an extremely slow rate, during which Li dendrites were effectively consumed and a small amount of LiOH was produced on the S-LMA surface, thereby effectively reducing the surface activity and the risk. Then the LiOH catalyzed the aldol condensation of acetone to produce diacetone alcohol (DAA) with low yields of less than 5 mol %. The DAA reacts with remaining S-LMA for forming Li compounds. The DAA subsequently reacted with S-LMA at acceptable, safe rates, which further drove the formation of DAA. Such a self-driven process led to a safe and complete conversion of the S-LMA. Particular configurations generate Li compounds including LiOH and LiDAA while consuming more than 99.5% of the S-LMA into the lithium compounds.

With subsequent purifications, the recovered Li₂CO₃ shows a high purity of 99.79 wt %, higher than the battery-grade standard (99.50 wt %). In one example, LiNi_{0.6}Mn_{0.2}Co_{0.2}O₂ (NMC622) cathode synthesized from the recovered Li₂CO₃ exhibits slightly superior performance to that of the NMC622 with commercial Li₂CO₃. This demonstrates the feasibility of the method for S-LMA recovery and offers a potential strategy for disposing of batteries with other reactive alkali-metal anodes. Additionally, the method demonstrates remarkable scalability and economic viability, further highlighting its practical potential.

FIGS. 2A and 2B depict the full recycling process, commencing with S-LMA 101 materials having dendrites 105 and LiPF₆. Sonication removes impurities, and the S-LMA 101 received in the acetone 110 containing a small amount of water. The S-LMA is initially received with the lithium dendrites 105 resulting from previous repetitive charge and discharge cycles, and the H₂O from the acetone solution first consumes the lithium dendrites 105. The S-LMA 101 reacts first with H₂O to form LiOH, shown as Reaction 1:

2Li+2H₂O→2LiOH+H₂↑

In this initial step, trace water forms LiOH and hydrogen gas, is intentionally slow due to very low water content The concentration of H₂O is sufficiently low to mitigate an exothermic reaction of the H₂O and the lithium. The H₂O forms the LiOH on a surface of the lithium metal, thereby limiting available reactive surface area.

The extremely low content of H₂O and the chemical inertness of acetone toward Li metal leads to a very slow reaction, although the S-LMA 101 has a much higher specific surface area than pristine Li metal. The slow reaction will both consume the Li dendrites 105 thereby reducing the risk of later reactions and also ensure that the temperature rise due to reaction 1 does not cause decomposition of surface components when the S-LMA is immersed in the solvent which is very different from the larger temperature changes in the acetone with higher water contents. Then, acetone will undergo aldol condensation to produce DAA with the LiOH catalysis, as shown in Reaction 2:

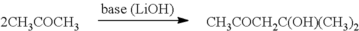

Reaction 2 is the base-catalyzed aldol condensation of acetone→diacetone alcohol (DAA), where the LiOH 114 catalyzes aldol concentration of the acetone for forming DAA less than 5% mol. The product is diacetone alcohol (DAA, C₆H₁₂O₂), while LiOH acts as the catalyst The yield is low, at around <10%, which is important for controlling reactivity.

The extremely low content of LiOH 114 leads to a slow rate of DAA production. Moreover, the yield of DAA in Reaction 2 should be less than around 10%, which indicates the production of DAA is thermodynamically limited, thus maintaining a low DAA concentration. In addition, compared with some common alcohols, DAA has a higher proton affinity (Eₚₐ) of 822.9 kJ mol⁻¹, indicating a more difficult deprotonation for DAA. It will lead to a slower reaction between DAA and the S-LMA compared with reactions between Li metal and alcohol.

The catalyzed reaction generates a low concentration of DAA, the DAA concentration increased by subsequent reactions with S-LMA. In Reaction 3:

$${C}_{6} {H}_{12} {O}_{2} + Li \to {C}_{6} {H}_{11} {O}_{2} Li + \frac{1}{2} {H}_{2}$$

The product is LiDAA This is a metal+alcohol reaction (alkoxide formation), and is slower than typical alcohol reactions due to DAA structure. Reaction with the S-LMA promotes the production of DAA, thus driving further conversion of the S-LMA. The Li alkoxide C₆H₁₁O₂Li (LiDAA), as a product of Reaction 3, is also a base, which catalyzes Reaction 2, thus accelerating the conversion of the S-LMA. The approach therefore forms LiDAA from contacting the DAA with the S-LMA, and catalyzes, via the LiDAA, the aldol condensation of the acetone, thereby forming a self-sustaining conversion of the S-LMA into the lithium compounds.

Notably, the solubilities of Li alkoxides in their corresponding alcohols are usually low indicating this acceleration may be limited, and therefore acceptable without undue effect. Overall, this tailored conversion strategy mitigates the challenges arising from the high chemical reactivity of S-LMA by maintaining slow initial reactions under extremely low water content, and the subsequent promotion by LiDAA catalysis then facilitates a moderate acceleration of the conversion, thereby enabling high safety while reducing conversion time. Based on the above reactions, all the S-LMAs can be converted into two Li compounds, LiOH and LiDAA 140, at controlled reaction rates. Further, LiDAA is easily converted into LiOH by hydrolysis and there are no by-products formed, which can further simply downstream formation of lithium carbonate 150 and Ni, Mn, Co cathode material 151.

In addition to realizing a safe conversion of the S-LMA shown in FIG. 2A, pre-treatments and purifications are also significant for getting the final products with high purities, as FIG. 2B shows the entire recycling process of the S-LMA. The pretreatment by ultrasonication is to remove the residual electrolytes, thereby removing any residual electrolytes from the S-LMA by agitating the S-LMA prior to addition of the acetone. Peaks of LiF becoming weaker after ultrasonication indicate that the residual LiPF₆ was removed significantly. Any LiF contents in the recovered Li₂CO₃ pretreated by different solvents also showed that pretreatment with EC-EMC (ethylene carbonate-ethyl methyl carbonate) mixture is effective in removing residual LiPF₆. Adding acetone at 142 after the above conversion favors obtaining more precipitated LiOH. Heating processes under O₂ and CO₂ may be used to remove the original organics from the S-LMA and convert LiOH to Li₂CO₃ (150) respectively. Then, the recovered Li₂CO₃ will be evaluated by characterization and used to synthesize NMC622 cathode 151 for further evaluation.

### Hydrolysis of LiDAA:

C₆H₁₁O₂Li+H₂O→C₆H₁₂O₂+LiOH

Converts LiDAA→LiOH for purification, and simplifies downstream chemistry. Conversion to lithium carbonate occurs during heating under CO₂:

2LiOH+CO₂→Li₂CO₃+H₂O

Produces the target product of battery-grade Li₂CO₃.
The collective summary of FIGS. 2A-2B define the following reactions:
1. Li+H₂O→LiOH+H₂
2. Acetone→DAA (LiOH-catalyzed aldol)
3. DAA+Li→LiDAA
4. LiDAA→LiOH (hydrolysis)
5. LiOH+CO₂→Li₂CO₃
   In contrast to conventional approaches, water starts the reaction safely via slow Li consumption, as the LiOH catalyzes aldol condensation. The DAA reacts with Li and drives equilibrium forward, to effectively form a self-sustaining (“self-driven”) reaction loop.

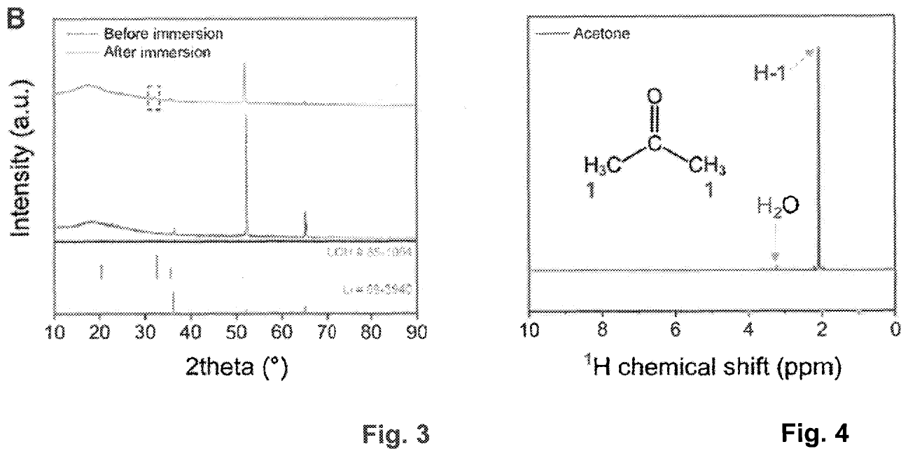

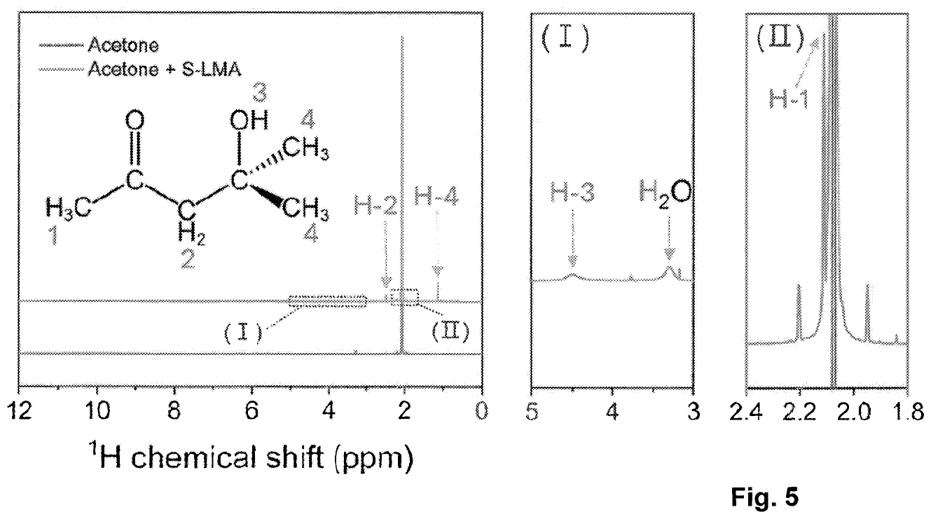

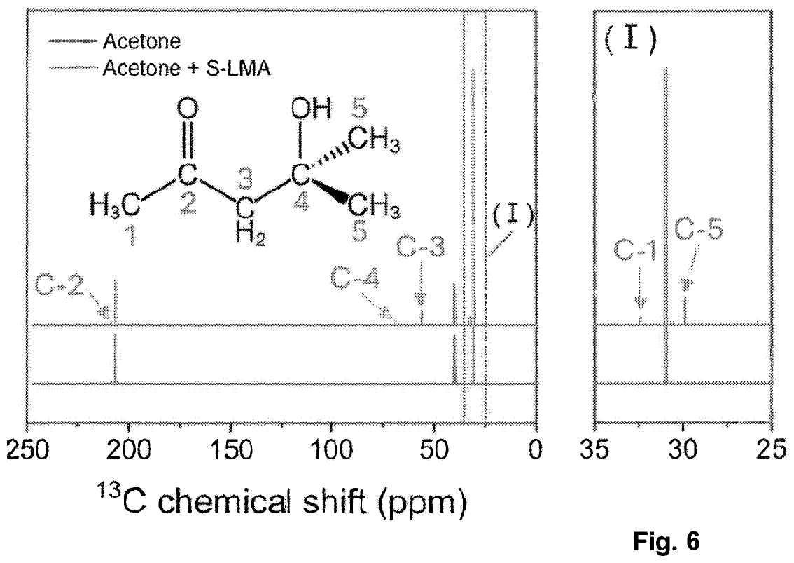

As the reactions of FIGS. 2A-2B proceed, a white flocculent first appears on the S-LMA surface accompanied by the production of bubbles after the S-LMA was immersed in the commercial acetone. The X-ray diffraction (XRD) pattern (FIG. 3) of the S-LMA attached with the white flocculent indicates that the white substance is LiOH (in the dotted box). The proton NMR (nu-clear magnetic resonance) spectrum of the initial solvent of FIG. 4 also shows that the solvent contains 0.41 wt % of H₂O. These results demonstrate that LiOH is first produced in the conversion process, which is consistent with FIG. 2A. After the formation of the white flocculent, the solvent was characterized by NMR. It can be found that DAA was formed by comparing the proton and carbon NMR spectra (FIGS. 5 and 6) of the solvent with the standard NMR spectra of DAA, which demonstrates Reaction 2. The content of the produced DAA is about 4.79 mol %, leading to a slow reaction with the S-LMA. Moreover, the DAA content, after mixing the above acetone and anhydrous LiOH powder then being kept over 100 days, is 4.26 mol %, which also shows that there is not much DAA accumulation and is consistent with the reported results.

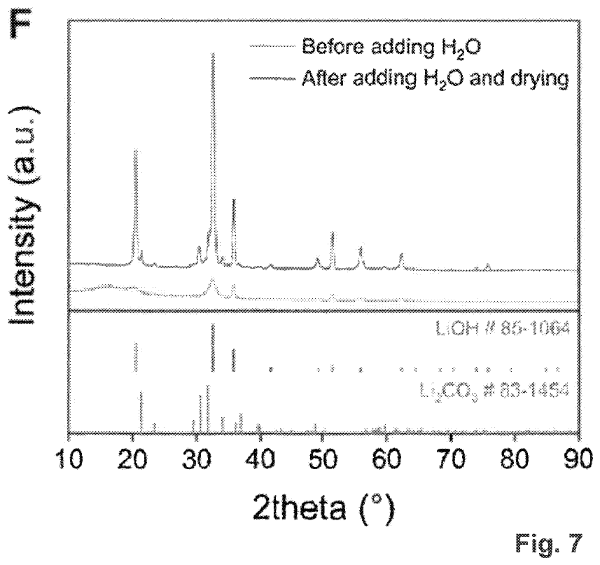

Therefore, the continued production of DAA was driven by the shift in the chemical equilibrium of Reaction 2 that was induced by Reaction 3. As the conversion proceeded, the mixture gradually became sticky, indicating more solid products were formed. The XRD pattern of the product in stage 3 after drying (FIG. 7) shows that it contains mainly LiOH, and there is an obvious but “unknown” broad peak between 10°-20°. As a comparison, the broad peak was not found after adding H₂O and drying, which indicates there may be some organics. To determine the composition of the dry product, it was dissolved into deionized (DI) H₂O and characterized by NMR. The proton and carbon NMR spectra show the hydroxyl group formed in the solution and both the spectra are almost the same as FIGS. 5 and 6, respectively, indicating DAA was produced. It also demonstrates that LiDAA is one of the conversion products, consistent with FIG. 2A. In addition, a slightly faster reaction than in the earlier stage indicates that there is a slight acceleration after the formation of LiDAA. The reaction rate is still slower than that of the reaction between pristine Li metal and ethanol, indicating the high safety of the conversion process. The high acetone content of 55.59 mol % in the solution may be from the decomposition of DAA in a basic environment. After the sample was kept for a longer time of 24 h, acetone, DAA, and any other organic impurities were not found in the solution according to the NMR spectrum, which means the conversion did not introduce organic impurities. The higher proton affinity of DAA than H₂O indicates that the further conversion of LiDAA to LiOH is thermodynamically spontaneous. The XRD pattern of FIG. 7 of the product after hydrolysis and drying shows that only LiOH and Li₂CO₃ are detected, demonstrating complete conversion.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of recycling lithium from lithium metal anodes, comprising:
combining a recycling stream of spent lithium metal anodes (S-LMA) and a solution of acetone and water;
forming LiOH resulting from the S-LMA and the H₂O, the LiOH catalyzing condensation of the acetone for forming diacetone alcohol (DAA); and
reacting the DAA with remaining S-LMA for forming Li compounds.

2. The method of claim 1 further comprising receiving the S-LMA with lithium dendrites resulting from previous repetitive charge and discharge cycles, and the H₂O from the acetone solution first consumes the lithium dendrites.

3. The method of claim 2 wherein the concentration of H₂O is sufficiently low to mitigate an exothermic reaction of the H₂O and the lithium.

4. The method of claim 2 wherein the H₂O forms the LiOH on a surface of the lithium metal, thereby limiting available reactive surface area.

5. The method of claim 1 wherein the LiOH catalyzes aldol concentration of the acetone for forming DAA less than 5% mol.

6. The method of claim 1 wherein the catalyzed reaction generates a low concentration of DAA, the DAA concentration increased by subsequent reactions with S-LMA.

7. The method of claim 1 wherein the LiOH reaction yield for DAA is thermodynamically limited to less than 10%.

8. The method of claim 1 further comprising:
forming LiDAA (lithium alkoxide) from contacting the DAA with the S-LMA; and
catalyzing, via the LiDAA, the aldol condensation of the acetone, thereby forming a self-sustaining conversion of the S-LMA into the lithium compounds.

9. The method of claim 1 wherein the acetone has an H₂O concentration of less than 1%.

10. The method of claim 1 wherein the Li compounds include LiOH and LiDAA, further comprising consuming 99.5% of the S-LMA into the lithium compounds.

11. The method of claim 1 further comprising removing residual electrolytes from the S-LMA by agitating the S-LMA prior to addition of the acetone.

12. The method of claim 1 further comprising forming LiDAA from the DAA and the Li in the S-LMA, and forming LiOH via hydrolysis.

13. The method of claim 12 further comprising forming Li₂CO₃ from the LiOH.
